(19) United States
(12) Patent Application Publication
(10) Pub. No.: US 2021/0374618 A1
(43) Pub. Date: Dec. 2, 2021

(54) LEARNING DEVICE AND DETERMINATION DEVICE

(71) Applicant: ASAHI KASEI KABUSHIKI KAISHA, Tokyo (JP)

(72) Inventors: Toshiyuki MIYAZAKI, Tokyo (JP); Rie HANAMI, Tokyo (JP); Munehiro KITAURA, Tokyo (JP)

(21) Appl. No.: 17/402,600

(22) Filed: Aug. 15, 2021

Related U.S. Application Data
(63) Continuation of application No. PCT/JP2020/008473, filed on Feb. 28, 2020.

(30) Foreign Application Priority Data
Feb. 28, 2019 (JP) 2019-035085

(51) Int. Cl. G06N 20/20; G06K 9/62

(52) U.S. Cl. CPC G06N 20/20; G06K 9/6262

(57) ABSTRACT

Provided is a learning device that includes an input unit configured to input training input data, training determination data for indicating a determination result with respect to the training input data, and training ground data for indicating a ground for the determination result with respect to the training input data; a determination learning unit, by performing first machine learning that learns a relationship between the training input data and the training determination data, configured to generate a determination inference model that, upon being inputted with input data, outputs inferred determination data; and a ground learning unit, by performing second machine learning that learns a relationship between the training input data and the training ground data, configured to generate a ground inference model that, upon being inputted with the input data, outputs inferred ground data.

The contents of the following Japanese patent applications are incorporated herein by reference:
NO. 2019-035085 filed in JP on Feb. 28, 2019
NO. PCT/JP2020/008473 filed in WO on Feb. 28, 2020

### BACKGROUND

### 1. Technical Field

The present invention relates to a learning device and a determination device.

### 2. Related Art

A learning device that performs machine learning on an input image viewed by a human expert and a result of a determination by the human expert with respect to the input image, and a determination device that estimates a result of a determination by a human expert are known (for example, refer to Patent Document 1).
Patent Document 1: Japanese Patent Application Publication No. 2018-92453

### SUMMARY

In the past, it has been difficult to verification the reliability of a determination result by a determination device. General Disclosure

In a first aspect of the present invention, a learning device is provided. The learning device is provided with an input unit that inputs training input data, training determination data for indicating a determination result with respect to the training input data, and training ground data for indicating a ground for the determination result with respect to the training input data; a determination learning unit that, by performing first machine learning that learns a relationship between the training input data and the training determination data, generates a determination inference model that, upon being inputted with determination target data, outputs inferred determination data for indicating a determination result with respect to the determination target data; and a ground learning unit that, by performing second machine learning that learns a relationship between the training input data and the training ground data, generates a ground inference model that, upon being inputted with the determination target data, outputs inferred ground data for indicating a ground for the determination result with respect to the determination target data.

At least some nodes of the determination inference model may be different from at least some of the nodes of the ground inference model.

The learning device may perform at least one of the first machine learning and the second machine learning based on a first error between the training determination data and the inferred determination data, and a second error between the training ground data and the inferred ground data.

The learning device may perform both of the first machine learning and the second machine learning based on the first error and the second error.

The learning device may perform at least one of the first machine learning and the second machine learning so that a sum of the first error and the second error becomes a minimum.

The learning device may perform at least one of the first machine learning and the second machine learning by differently weighting the first error and the second error to differ.

The determination learning unit may perform the first machine learning, in which the first error is reduced, independently of the second machine learning. The ground learning unit may perform the second machine learning, in which the second error is reduced, independently of the first machine learning. The determination learning unit and the ground learning unit may respectively perform the first machine learning and the second machine learning so that a sum of the first error and the second error becomes a minimum.

The determination inference model may include at least some nodes from the ground inference model.

At least one node of the ground inference model may include a node to which the determination target data is inputted.

In a second aspect of the present invention, a determination device is provided. The determination device is provided with a first inference unit that outputs a determination result with respect to determination target data, based on a determination inference model generated by performing machine learning on the relationship between training input data and training determination data; and a second inference unit that outputs a ground for the determination result with respect to the determination target data, based on a ground inference model generated by performing machine learning on the relationship between the training input data and training ground data.

The determination device may be provided with a display unit. The display unit may have a determination target data display region that displays the determination target data, a determination result display region that displays the determination result, and a determination ground display region that displays a ground of the determination result.

The summary clause does not necessarily describe all necessary features of the embodiments of the present invention. The present invention may also be a sub-combination of the features described above.

### BRIEF DESCRIPTION OF THE DRAWINGS

FIG. 1 illustrates an example of a learning device 100 according to one embodiment of the present invention.

FIG. 2 schematically illustrates an example of first machine learning 60 and second machine learning 70.

FIG. 3 illustrates a flowchart of the first machine learning 60 and the second machine learning 70.

FIG. 4 illustrates another example of the learning device 100 according to one embodiment of the present invention.

FIG. 5 schematically illustrates an example of the first machine learning 60 and the second machine learning 70 in the example of FIG. 4.

FIG. 6 illustrates a flowchart of the first machine learning 60 and the second machine learning 70 in the example of FIG. 4 and FIG. 5.

FIG. 7 schematically illustrates another example of the first machine learning 60 and the second machine learning 70.

FIG. 8 illustrates an example of a determination device 200 according to one embodiment of the present invention.

FIG. 9 illustrates an example of outputs for a determination result 28 and a ground 38 for the determination result, in accordance with the determination device 200.

FIG. 10 illustrates an example of the determination device 200.

### DESCRIPTION OF EXEMPLARY EMBODIMENTS

Description is given below for the present invention by means of embodiments of the invention, but the following embodiments do not limit the invention according to the claims. There is no limitation to all combinations of features described in an embodiment being essential to a means for solving the problems of the invention.

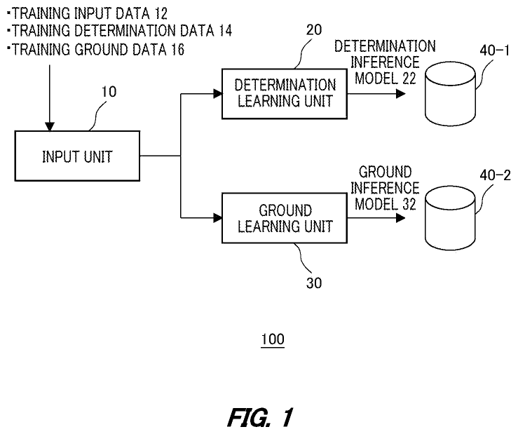

FIG. 1 illustrates an example of a learning device 100 according to one embodiment of the present invention. The learning device 100 is provided with an input unit 10, a determination learning unit 20, and a ground learning unit 30. Training input data 12, training determination data 14, and training ground data 16 are inputted to the input unit 10. The input unit 10 inputs the training input data 12 and the training determination data 14 to the determination learning unit 20. The input unit 10 inputs the training input data 12 and the training ground data 16 to the ground learning unit 30.

The training input data 12 is training data for which a predetermined determination pertaining to the data has already been made. The training input data 12 may be data that includes predetermined types of information, such as image data, audio data, and text data. As a more specific example, the training input data 12 is image data that includes images of products such as vegetables, fruit, and meat.

The training determination data 14 is data that indicates a determination result with respect to the training input data 12. The training determination data 14 may be data that indicates a result of a determination made by a human determiner or another type of determiner with respect to the training input data 12. It is desirable for the determination to be performed by an expert. The training determination data 14 may be data that indicates one or more results that are selected by the determiner from a plurality of results set in advance as options. For example, when the training input data 12 is image data pertaining to a product, the training determination data 14 may be data that indicates an evaluation result of evaluating the quality of the product. The training determination data 14 is inputted to the input unit 10 in a state in which the training determination data 14 is associated with the training input data 12 with respect to which the determination was made.

The training ground data 16 is data that indicates, with respect to the training input data 12, a ground for determining the result indicated by the training determination data 14. The training ground data 16 may be data that is inputted as a ground for the determination made by a human determiner, or another type of determiner, who determined the result indicated by the training determination data 14. The training ground data 16 may be data that indicates one or more grounds that are selected by the determiner from a plurality of grounds set in advance as options. The training ground data 16 may be data that designates some information included in the training input data 12. The training ground data 16 may be data that designates a region for a portion of an image included in the training input data 12, or may be data that indicates a characteristic of a region for a portion of the image. For example, when the determiner determines from image data included in the training input data 12, with discoloration of a predetermined portion of the skin of a fruit as a ground, that the fruit is of poor quality, the training ground data 16 is data indicating that the fruit skin of the predetermined portion of the fruit is discolored. The training ground data 16 is inputted to the input unit 10 in a state in which the training ground data 16 is associated with the training input data 12 with respect to which the determination was made.

The determination learning unit 20 performs first machine learning that learns the relationship between the training input data 12 and the training determination data 14, and generates a determination inference model 22. The determination inference model 22, upon being inputted with input data, performs predetermined processing on the input data and outputs inferred determination data indicating a determination result with respect to the input data. The determination learning unit 20 optimizes the processing in the determination inference model 22 by learning the relationship between many items of training input data 12 and training determination data 14.

The ground learning unit 30 performs second machine learning that learns the relationship between the training input data 12 and the training ground data 16, and generates a ground inference model 32. The ground inference model 32, upon being inputted with input data, performs predetermined processing on the input data and outputs inferred ground data indicating a ground for a determination result with respect to the input data. The ground learning unit 30 optimizes the processing in the ground inference model 32 by learning the relationship between many items of training input data 12 and training ground data 16.

The learning device 100 may be provided with a storage unit 40-1 and a storage unit 40-2. The storage unit 40-1 stores the determination inference model 22 generated by the determination learning unit 20. The storage unit 40-2 stores the ground inference model 32 generated by the ground learning unit 30.

The learning device 100 of the present example performs the second machine learning that learns the relationship between the training input data 12 and the training ground data 16, in addition to the first machine learning that learns the relationship between the training input data 12 and the training determination data 14. In other words, the learning device 100 generates the ground inference model 32 in addition to the determination inference model 22. The learning device 100 can output both of inferred determination data and inferred ground data for new input data by using the determination inference model 22 and the ground inference model 32. Accordingly, it is easier for a user to verify the appropriateness of the inferred determination data based on the inferred ground data. In addition, because it is possible to also present the inferred ground data to a user who is presented with the inferred determination data, it is easier for the user to interpret the inferred determination data. When only the inferred determination data is presented to a user without being accompanied by the inferred ground data, the user is more likely to be in doubt about a determination of whether a result indicated by the inferred determination data is appropriate.

The training input data 12 may be image data pertaining to a product such as vegetables or meat, data pertaining to investment such as fluctuation of a stock price, or data pertaining to a medical diagnosis or another type of diagnosis. When the training input data 12 is data pertaining to investment such as fluctuation of a stock price, the training determination data 14 may be data determined by a human expert on whether or not to invest based on the training input data 12 that is, for example, fluctuation of a stock price. In addition, the training ground data 16 may be ground data on a determination made by a human expert on whether or not to carry out the investment. When the training input data 12 is data pertaining to a medical diagnosis or another type of diagnosis, the training determination data 14 may be data relating to details of a treatment decided by a human expert based on the data pertaining to the medical diagnosis or another type of diagnosis. In addition, the training ground data 16 may be ground data in which a human expert has decided on the details of this treatment.

When the training input data 12 is data pertaining to a medical diagnosis or another type of diagnosis, the training input data 12, more specifically, may be data with respect to various medical cases, such as a medical image or a video which includes an MRI, a CT, or an echo image, or a vital signal which includes an electro-cardiogram or respiratory sounds. In this case, the training determination data 14 may be a disease name determined by a doctor based on the training input data 12 described above. The learning device 100 may perform the first machine learning that learns the relationship between the training input data 12 and the training determination data 14 described above, and generate the determination inference model 22. Furthermore, the training ground data 16 may be data that includes, as the determination ground, a finding by a doctor on the training input data 12 described above. The learning device 100 may perform the second machine learning that learns the relationship between the training input data 12 and the training ground data 16 described above, and generate the ground inference model 32. As a result, a determination device according to the present embodiment may output a disease name based on the determination inference model 22 as a determination result with respect to input data such as a medical image or a video which includes an MRI, a CT, or an echo image, or a vital signal which includes an electro-cardiogram or respiratory sounds, and, based on the ground inference model 32, output a finding that is a determination ground for the determination result. A doctor makes a final determination based on these items of information. By this, it is possible to prevent an oversight on the disease by the doctor and an indetermination by the determination device, at the same time.

In addition, the training input data 12 may be personnel data. When the training input data 12 is personnel data, the training input data 12 may more specifically be an employee profile. In this case, the training determination data 14 may be data that includes performance by the employee in a predetermined range of activities (such as research and development, or sales). The learning device 100 may perform the first machine learning that learns the relationship between the training input data 12 and the training determination data 14 described above, and generate the determination inference model 22. Furthermore, the training ground data 16 may be data that includes a ground (reason) why the employee has achieved the performance. The learning device 100 may perform the second machine learning that learns the relationship between the training input data 12 and the training ground data 16 described above, and generate the ground inference model 32. As a result, a determination device according to the present embodiment outputs performance expected of a recruitment target person based on the determination inference model 22 as a determination result with respect to personnel data such as an employee profile, and, based on the ground inference model 32, outputs a ground why the performance will be exercised as the determination ground for the determination result. In this manner, it is possible to use the learning device and the determination device according to the present embodiment for recruitment activities or personnel assessment in a company.

In addition, the training input data 12 may be data pertaining to an equipment inspection in a factory. When the training input data 12 is data pertaining to an equipment inspection, the training input data 12 may, more specifically, be data that is an image or an operation sound of an equipment inspection target object in the factory. In this case, the training determination data 14 may be data that includes an inspection result (requires replacement, requires detailed inspection, no serious problem, and so on) by an expert on the equipment inspection target object. The learning device 100 may perform the first machine learning that learns the relationship between the training input data 12 and the training determination data 14 described above, and generate the determination inference model 22. Furthermore, the training ground data 16 may be data that includes a ground for a determination by an expert with respect to the data on the equipment inspection target object. The learning device 100 may perform the second machine learning that learns the relationship between the training input data 12 and the training ground data 16 described above, and generate the ground inference model 32. As a result, a determination device according to the present embodiment may output, based on the determination inference model 22, an inspection result on an inspection target object as a determination result with respect to input data such as an image or an operation sound of the inspection target object, and output, based on the ground inference model 32, the determination ground for the determination result. By this, it is possible to use the learning device and the determination device according to the present embodiment in an equipment inspection in a factory.

It is possible to use a publicly known algorithm for each of the first machine learning and the second machine learning. It is possible to give, as a publicly known algorithm, for example, a neural network, a random forest, gradient boosting, ridge regression, Lasso, logistic regression, a support vector machine (SVM), and so on. The type of a neural network may be a convolution type, a recurrent type, a time delay type, or the like. The determination inference model 22 and the ground inference model 32 may respectively output, with respect to input data, a classification result and a ground for the classification result, and may respectively output, with respect to input data, a regression result and a ground for the regression result.

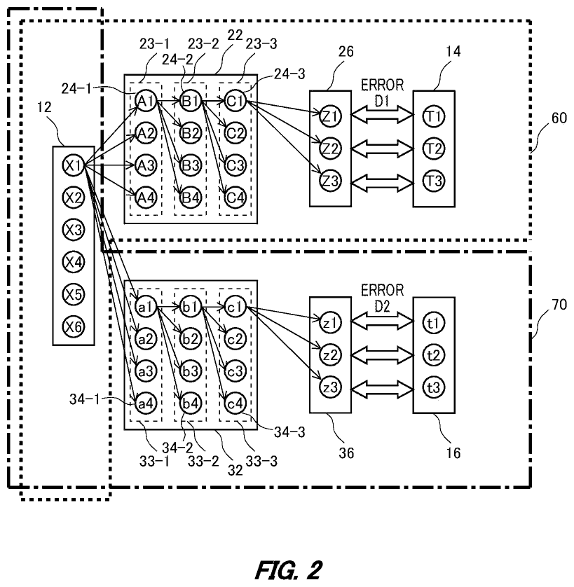

FIG. 2 schematically illustrates an example of the first machine learning 60 and the second machine learning 70. The determination inference model 22 has a plurality of layers 23. Each layer 23 has a plurality of nodes 24. Each node 24 performs a predetermined calculation with respect to an inputted parameter. The determination inference model 22 outputs inferred determination data 26 based on results of predetermined calculations by the plurality of nodes 24 in the plurality of layers 23. The learning device 100 calculates a first error D1 by comparing the inferred determination data 26 and the training determination data 14.

In the present specification, in FIG. 2, a side on which the training input data 12 is inputted is referred to as a input side, and a side on which the inferred determination data 26 is outputted is referred to as a output side. The determination inference model 22 may continuously have a plurality of layers 23 from the input side to the output side. Calculation results for a plurality of nodes 24 that belong to one layer 23 may be respectively inputted to a plurality of nodes 24 that belong to another layer 23. This another layer 23 may be a layer that is on the output side of the one layer 23.

As an example, the determination inference model 22 illustrated in FIG. 2 has three layers 23 and each of the three layers 23 has four nodes 24. The determination inference model 22 of this example continuously has a layer 23-1, a layer 23-2, and a layer 23-3 from the input side to the output side. The layer 23-1 has four nodes 24-1, the layer 23-2 has four nodes 24-2, and the layer 23-3 has four nodes 24-3. In FIG. 2, the four nodes 24-1 are indicated by A1 through A4, the four nodes 24-2 are indicated by B1 through B4, and the four nodes 24-3 are indicated by C1 through C4.

The four nodes 24-1 perform predetermined calculations on six items of training input data 12 respectively indicated by X1 through X6, and output results of these calculations to the four nodes 24-2. In FIG. 2, arrows are only illustrated from X1 to A1 through A4, and arrows from X2 through X6 to A1 through A4 are omitted. The four nodes 24-1 may perform the calculations by applying predetermined weighting with respect to each of the six items of training input data 12.

The four nodes 24-2 perform predetermined calculations on the outputs from the four nodes 24-1, and output results of these calculations to the four nodes 24-3. In FIG. 2, only arrows from A1 to B1 through B4 are illustrated, and arrows from A2 through A4 to B1 through B4 are omitted. The four nodes 24-2 may perform the calculations by applying predetermined weighting with respect to the output from each of the four nodes 24-1.

The four nodes 24-3 perform predetermined calculations on the outputs from the four nodes 24-2, and output results of these calculations. In FIG. 2, only arrows from B1 to C1 through C4 are illustrated, and arrows from B2 through B4 to C1 through C4 are omitted. The four nodes 24-3 may perform the calculations by applying predetermined weighting with respect to the output from each of the four nodes 24-2.

Three items of inferred determination data 26 indicated by Z1 through Z3 are generated by performing predetermined calculations on the outputs from the four nodes 24-3. In FIG. 2, only arrows from C1 to Z1 through Z3 are illustrated, and arrows from C2 through C4 to Z1 through Z3 are omitted. The three items of inferred determination data 26 may be calculated by applying predetermined weighting with respect to the output from each of the four nodes 24-3.

The learning device 100 compares the three items of inferred determination data 26 Z1 through Z3 with three items of training determination data 14 indicated by T1 through T3, respectively. The learning device 100 respectively compares Z1 through Z3 with T1 through T3, and calculates a first error D1.

The ground inference model 32 has a plurality of layers 33. Each layer 33 has a plurality of nodes 34. Each node 34 performs a predetermined calculation with respect to an inputted parameter. The ground inference model 32 outputs inferred ground data 36 based on results of predetermined calculations by the plurality of nodes 34 in the plurality of layers 33. The learning device 100 calculates a second error D2 by comparing the inferred ground data 36 with the training ground data 16.

In the present specification, in FIG. 2, a side where the training input data 12 is inputted is referred to as a input side, and a side where the inferred ground data 36 is outputted is referred to as a output side. The ground inference model 32 may continuously have a plurality of layers 33 from the input side to the output side. Calculation results for a plurality of nodes 34 that belong to one layer 33 may be respectively inputted to a plurality of nodes 34 that belong to another layer 33. This another layer 33 may be a layer that is on the output side of the one layer 33.

As an example, the ground inference model 32 illustrated in FIG. 2 has, from a side where the training input data 12 is inputted, three layers 33, and each of the three layers 33 has four nodes 34. The ground inference model 32 of the present example continuously has a layer 33-1, a layer 33-2, and a layer 33-3 from the input side to the output side. The layer 33-1 has four nodes 34-1, the layer 33-2 has four nodes 34-2, and the layer 33-3 has four nodes 34-3. In FIG. 2, the node 34-1, the node 34-2, and the node 34-3 are respectively indicated by a1 through a4, b1 through b4, and c1 through c4.

The four nodes 34-1 perform predetermined calculations on six items of training input data 12 respectively indicated by X1 through X6, and output results of these calculations to the four nodes 34-2. In FIG. 2, arrows are only illustrated from X1 to a1 through a4, and arrows from X2 through X6 to a1 through a4 are omitted. The four nodes 34-1 may perform the calculations by applying predetermined weighting with respect to each of the six items of training input data 12.

The four nodes 34-2 perform predetermined calculations on the outputs from the four nodes 34-1, and output results of these calculations to the four nodes 34-3. In FIG. 2, only arrows from a1 to b1 through b4 are illustrated, and arrows from a2 through a4 to b1 through b4 are omitted. The four nodes 34-2 may perform the calculations by applying predetermined weighting with respect to the output from each of the four nodes 34-1.

The four nodes 34-3 perform predetermined calculations on the outputs from the four nodes 34-2, and output results of these calculations. In FIG. 2, only arrows from b1 to c1 through c4 are illustrated, and arrows from b2 through b4 to c1 through c4 are omitted. The four nodes 34-3 may perform the calculations by applying predetermined weighting with respect to the output from each of the four nodes 34-2.

Three items of inferred ground data 36 indicated by z1 through z3 are generated by performing predetermined calculations on the outputs from the four nodes 34-3. In FIG. 2, only arrows from c1 to z1 through z3 are illustrated, and arrows from c2 through c4 to z1 through z3 are omitted. The three items of inferred ground data 36 may be calculated by applying predetermined weighting with respect to the output from each of the four nodes 34-3.

The learning device 100 compares z1 through z3 with three items of training ground data 16 indicated by t1 through t3, respectively. The learning device 100 respectively compares z1 through z3 with t1 through t3, and calculates a second error D2.

At least one node 24 of the determination inference model 22 may be different to at least one node 34 of the ground inference model 32. The at least one node 24 being different to at least one node 34 indicates that the ground inference model 32 does not have the at least one node 24, and that the determination inference model 22 does not have the at least one node 34. In the present example, all of the nodes 24 of the determination inference model 22 differ from all of the nodes 34 of the ground inference model 32. In other words, in the present example, the determination learning unit 20 and the ground learning unit 30 independently perform the first machine learning 60 and the second machine learning 70, respectively.

The number of layers 23 may be more than three. The number of nodes 24 that a layer 23 has may be more than four and may be less than four. The number of nodes 24 that the layer 23-1, the layer 23-2, and the layer 23-3 have may be respectively different. Similarly, the number of layers 33 may be more than three. The number of nodes 34 that a layer 33 has may be more than four and may be less than four. The number of nodes 34 that the layer 33-1, the layer 33-2, and the layer 33-3 have may be respectively different. The number of layers 23 and the number of layers 33 may be different.

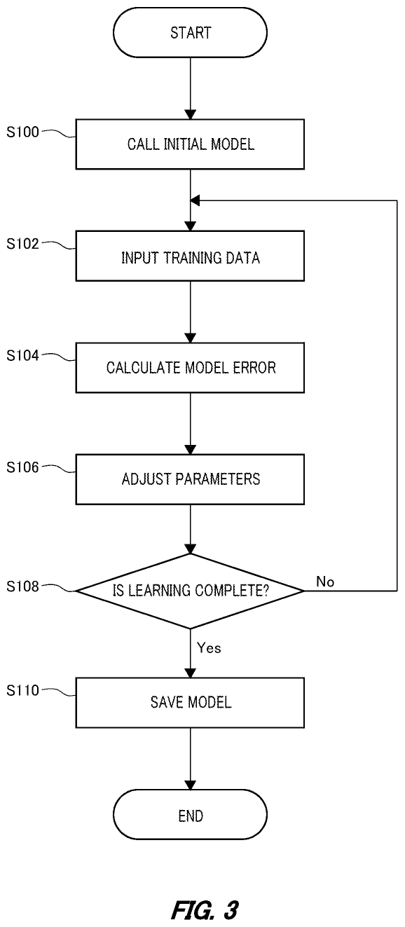

FIG. 3 illustrates a flowchart of the first machine learning 60 and the second machine learning 70. In step S100, the learning device 100 loads initial models for the determination inference model 22 and the ground inference model 32. The initial models may be stored in the storage unit 40-1 and the storage unit 40-2 (refer to FIG. 1), respectively.

In step S102, the learning device 100 inputs the training input data 12, the training determination data 14, and the training ground data 16 to the input unit 10. The determination learning unit 20 performs the first machine learning 60 that learns the relationship between the training input data 12 and the training determination data 14. The ground learning unit 30 performs the second machine learning 70 that learns the relationship between the training ground data 16 and the training determination data 12. The determination learning unit 20 generates the determination inference model 22 by performing the first machine learning 60. The ground learning unit 30 generates the ground inference model 32 by performing the second machine learning 70.

In step S104, the learning device 100 calculates model errors. The model errors indicate the first error D1 between the inferred determination data 26 outputted by the determination inference model 22 and the training determination data 14, and the second error D2 between the inferred ground data 36 outputted by the ground inference model 32 and the training ground data 16.

Let a first error function f1 and a second error function f2 be functions for calculating the first error D1 and the second error D2, respectively. The learning device 100 may calculate the first error D1 by inputting the inferred determination data 26 and the training determination data 14 to the first error function f1. The learning device 100 may calculate the second error D2 by inputting the inferred ground data 36 and the training ground data 16 to the second error function f2.

The first error function f1 and the second error function f2 may be any publicly known loss function such as a mean squared error function, a mean absolute error function, a mean squared logarithmic error function, a cross-entropy error function, a function that uses connectionist temporal classification, a hinge loss function, a Huber function, an exponential loss function, and a KL divergence (Kullback-Leibler divergence) function. The first error function f1 and the second error function f2 may be the same and do not need to be same.

In step S106, the learning device 100 adjusts, based on the first error D1, weighting coefficients (parameters) for the calculations in the nodes 24, and adjusts, based on the second error D2, weighting coefficients (parameters) for the calculations in the nodes 34. The learning device 100 may adjust, based on the first error D1, the weighting coefficient for each of the nodes 24 that respectively belong to the plurality of layers 23. The learning device 100 may adjust, based on the second error D2, the weighting coefficient for each of the nodes 34 that respectively belong to the plurality of layers 33. In other words, the weighting coefficient may be different for each of the nodes 24 that respectively belong to the plurality of layers 23, and may be different for each of the nodes 34 that respectively belong to the plurality of layers 33.

In the example illustrated in FIG. 2, the learning device 100 adjusts, based on the first error D1, the weighting coefficients (parameters) between the six items of training input data 12 and the four nodes 24-1, between the four nodes 24-1 and the four nodes 24-2, between the four nodes 24-2 and the four nodes 24-3, and between the four nodes 24-3 and the three items of inferred determination data 26. The learning device 100 also adjusts, based on the second error D2, the weighting coefficients (parameters) between the six items of training input data 12 and the four nodes 34-1, between the four nodes 34-1 and the four nodes 34-2, between the four nodes 34-2 and the four nodes 34-3, and between the four nodes 34-3 and the three items of inferred ground data 36.

In step S108, the learning device 100 determines whether or not the determination inference model 22 and the ground inference model 32 have respectively completed the first machine learning 60 and the second machine learning 70. The learning device 100 may determine whether to complete the first machine learning 60 by comparing a first threshold T1 that is defined in advance with the first error D1. The learning device 100 may determine whether to complete the second machine learning 70 by comparing a second threshold T2 that is defined in advance with the second error D2. The first threshold T1 and the second threshold T2 may be different, and may be the same.

When the first error D1 is greater than the first threshold T1, the learning device 100 returns to step S102, and inputs the training input data 12 and the training determination data 14 to the input unit 10. When the second error D2 is greater than the second threshold T2, the learning device 100 returns to step S102, and inputs the training input data 12 and the training ground data 16 to the input unit 10.

Every time the learning device 100 returns from step S108 to step S102, the learning device 100 may input different training input data 12, different training determination data 14, and different training ground data 16 to the input unit 10. Each time the loop of step S102 through step S108 is repeated, the determination learning unit 20 repeats the first machine learning 60 and the ground learning unit 30 repeats the second machine learning 70, and thus the accuracy of the determination inference model 22 and ground inference model 32 improves. Accordingly, the determination inference model 22 and the ground inference model 32 can respectively output, with respect to determination target data, a determination result and a ground for the determination result that have high accuracy.

When the first error D1 has become less than the first threshold T1 after repeating the loop of step S102 through step S108, the learning device 100 completes the first machine learning 60 and proceeds to step S110. Similarly, when the second error D2 has become less than the second threshold T2 after repeating the loop of step S102 through step S108, the learning device 100 completes the second machine learning 70 and proceeds to step S110. In step S110, the learning device 100 may save the determination inference model 22 and the ground inference model 32 in the storage unit 40-1 and the storage unit 40-2, respectively.

The determination learning unit 20 may perform the first machine learning 60, in which the first error D1 is reduced, independently of the second machine learning 70. The ground learning unit 30 may perform the second machine learning 70, in which the second error D2 is reduced, independently of the first machine learning 60. In other words, the determination learning unit 20 may perform the first machine learning 60 without being influenced by the inferred ground data 36, and the ground learning unit 30 may perform the second machine learning 70 without being influenced by the inferred determination data 26.

The learning device 100 may perform the first machine learning 60 and the second machine learning 70 in parallel. The learning device 100 may perform the second machine learning 70 after performing the first machine learning 60, and may perform the first machine learning 60 after performing the second machine learning 70.

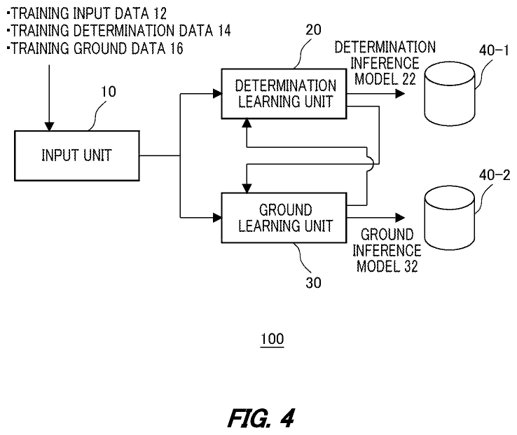

FIG. 4 illustrates another example of the learning device 100 according to one embodiment of the present invention. The learning device 100 of the present example differs from the learning device 100 of FIG. 1 in that a learning result from the first machine learning 60 in the determination learning unit 20 is fed back to the ground learning unit 30, and a learning result from the second machine learning 70 in the ground learning unit 30 is fed back to the determination learning unit 20.

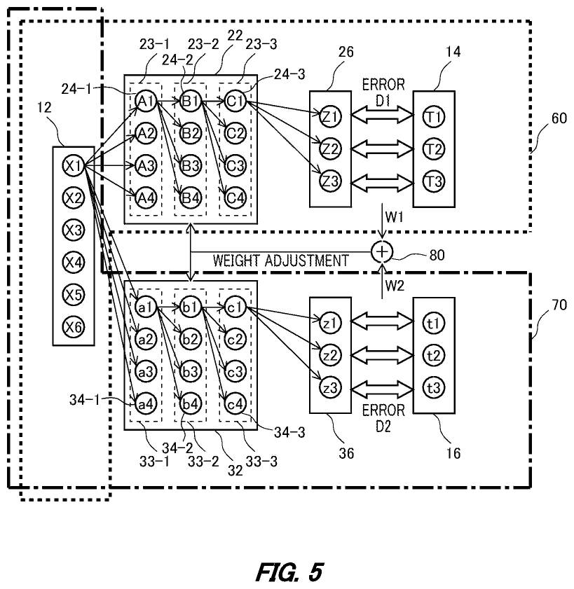

FIG. 5 schematically illustrates an example of the first machine learning 60 and the second machine learning 70 in the example of FIG. 4. In the present example, the learning device 100 performs at least one of the first machine learning 60 and the second machine learning 70 based on the first error D1 between the training determination data 14 and the inferred determination data 26, and the second error D2 between the training ground data 16 and the inferred ground data 36. The learning device 100 may perform both of the first machine learning 60 and the second machine learning 70 based on the first error D1 and the second error D2.

By performing at least one of the first machine learning 60 and the second machine learning 70 based on the first error D1 and the second error D2, the learning device 100 can reflect a learning result from the ground inference model 32 in learning for the determination inference model 22. As a result, the determination learning unit 20 can construct a determination inference model 22 that reflects the hidden relationship between the training determination data 14 and the training ground data 16, in comparison to a case where the determination learning unit 20 is caused to learn learns the determination inference model 22 and the ground inference model 32 independent from each other.

The learning device 100 may perform the first machine learning 60, in which the first error D1 is reduced independently of the second machine learning 70, and then perform the first machine learning 60 based on the first error D1 and the second error D2. By this, the learning device 100 can cause the first machine learning 60 to converge quicker than when the learning device 100 performs the first machine learning 60 and the second machine learning 70 in parallel.

The learning device 100 may perform the second machine learning 70, in which the second error D2 is reduced, independently of the first machine learning 60, and then perform the second machine learning 70 based on the first error D1 and the second error D2. By this, the learning device 100 can cause the second machine learning 70 to converge quicker than when the learning device 100 performs the first machine learning 60 and the second machine learning 70 in parallel.

The learning device 100 may perform a predetermined calculation on the first error D1 and the second error D2 in a node 80. The predetermined calculation may include a sum of the first error D1 and the second error D2, an average of the first error D1 and the second error D2, and a weighted average of the first error D1 and the second error D2. The learning device 100 may perform at least one of the first machine learning 60 and the second machine learning 70 based on a result of performing the predetermined calculation on the first error D1 and the second error D2 in the node 80. A result of performing the predetermined calculation on the first error D1 and the second error D2 may be fed back to any of the plurality of nodes 24, and may be fed back to any of the plurality of nodes 34. In the example of FIG. 5, the result of performing the predetermined calculation on the first error D1 and the second error D2 may be fed back to any of the nodes 24-1 through the nodes 24-3, and may be fed back to any of the plurality of nodes 34-1 through the nodes 34-3.

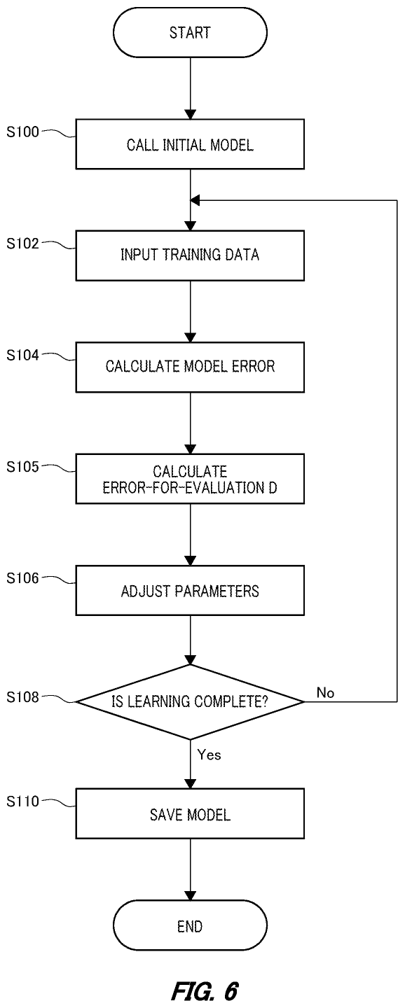

FIG. 6 illustrates a flowchart of the first machine learning 60 and the second machine learning 70 in the example of FIG. 4 and FIG. 5. The flowchart of FIG. 6 differs from the flowchart of FIG. 3 in that the flowchart of FIG. 6 also has a step S105 that calculates an error for evaluation between step S104 and step S106 of FIG. 3. Operations by the learning device 100 other than step S105 are the same as the steps in FIG. 3.

In step S104, the learning device 100 calculates model errors. The model errors indicate an error D1 (first error D1) between the inferred determination data 26 outputted by the determination inference model 22 and the training determination data 14, and an error D2 (second error D2) between the inferred ground data 36 outputted by the ground inference model 32 and the training ground data 16.

In step S105, the learning device 100 calculates an error-for-evaluation D from the model errors. The error-for-evaluation D indicates an error resulting from the learning device 100 performing a predetermined calculation on the model errors.

The learning device 100 may calculate a composite error using the first error D1 and the second error D2. The composite error is referred to as the composite error MD. The learning device 100 may perform the first machine learning 60 or the second machine learning 70 based on the composite error MD. The composite error MD may be the sum of the first error D1 and the second error D2. Using the sum of the first error D1 and the second error D2 as the composite error MD, the learning device 100 may perform at least one of the first machine learning 60 and the second machine learning 70 so that the composite error MD becomes a minimum. In other words, the learning device 100 may set the error-for-evaluation D (composite error MD) as the sum of the first error D1 and the second error D2, and perform at least one of the first machine learning 60 and the second machine learning 70 so that the error-for-evaluation D becomes a minimum. The learning device 100 may calculate the error-for-evaluation D in step S105 every time the loop of step S102 through step S108 is repeated, and repeat the loop of step S102 through step S108 until the error-for-evaluation D becomes a minimum.

Because the learning device 100 of the present example repeats the first machine learning 60 and the second machine learning 70 until the error-for-evaluation D becomes a minimum, the accuracy of the determination inference model 22 and the ground inference model 32 improves. Accordingly, the determination inference model 22 and the ground inference model 32 can respectively output, with respect to input data, a determination result and a ground for the determination result that have high accuracy.

The learning device 100 may perform at least one of the first machine learning 60 and the second machine learning 70 while using a result of causing weighting for the first error D1 and the second error D2 to be different as the composite error MD. In other words, the learning device 100 may perform at least one of the first machine learning 60 and the second machine learning 70 using a composite error MD calculated by differently weighting the first error D1 and the second error D2 to be different as the error-for-evaluation D. The error-for-evaluation D may be a weighted average of the first error D1 and the second error D2. By performing the first machine learning 60 or the second machine learning 70 using the error-for-evaluation D resulting from causing weighting for the first error D1 and the second error D2 to be different, the learning device 100 can adjust the learning by setting which of a determination result and a ground for the determination result to emphasize accuracy for.

The learning device 100 may be able to adjust the weighting for the first error D1 and the second error D2 in the composite error MD. The learning device 100 may perform at least one of the first machine learning 60 and the second machine learning 70 using a composite error MD in which the weighting is changed every predefined number of steps. For example, when performing the first machine learning 60, the learning device 100 may perform the first machine learning 60 while initially setting the weighting for one error (for example, the first error D1) in the composite error MD to be large, and, every time the number of steps advances, perform the first machine learning 60 while increasing the weighting for the other error (for example, the second error D2). By this, the learning device 100 can strike a balance between convergence speed for the first machine learning 60 and accuracy of the generated determination inference model 22. In this case, the learning device 100 may adjust the weighting in accordance with the convergence situation for the first machine learning 60. In addition, when performing the second machine learning 70, the learning device 100 may performing the second machine learning 70 while initially setting the weighting for one error (for example, the second error D2) in the composite error MD to be large, and, every time the number of steps advances, perform the second machine learning 70 while increasing the weighting for the other error (for example, the first error D1). By this, the learning device 100 can strike a balance between convergence speed for the second machine learning 70 and accuracy of the generated determination ground model 32. In this case, the learning device 100 may adjust the weighting in accordance with the convergence situation for the second machine learning 70.

When repeating the loop of step S102 through step S108, it may be that the determination learning unit 20 performs the first machine learning 60 in which the first error D1 is made smaller independently of the second machine learning 70, the ground learning unit 30 performs the second machine learning 70 in which the second error D2 is made smaller independently of the first machine learning 60, and then determination learning unit 20 and the ground learning unit 30 respectively perform the first machine learning 60 and the second machine learning 70 so that the sum of the first error D1 and the second error D2 becomes a minimum. In other words, the learning device 100 may repeat the loop of step S102 through step S108 in FIG. 3 a predetermined number of times, and then repeat the loop of step S102 through step S108 in FIG. 6. In addition, the learning device 100 may repeat the loop of step S102 through step S108 in FIG. 6 a predetermined number of times, and then repeat the loop of step S102 through step S108 in FIG. 3. The learning device 100 may alternatingly repeat the loop in FIG. 3 and the loop in FIG. 6 a plurality of times.

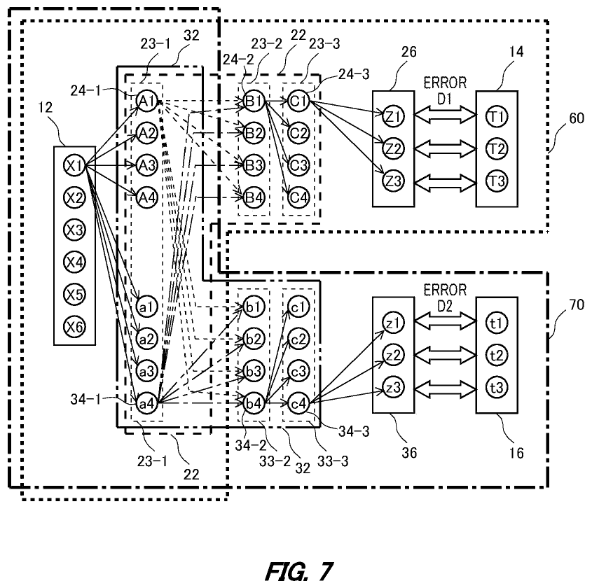

FIG. 7 schematically illustrates another example of the first machine learning 60 and the second machine learning 70. The determination inference model 22 may include at least one node 34 from the ground inference model 32. In addition, the ground inference model 32 may include at least one node 24 from the determination inference model 22.

In the example illustrated in FIG. 7, the four nodes 24-1 perform calculations on six items of training input data 12 respectively indicated by X1 through X6 by applying predetermined weightings thereto, and output results of these calculations to the four nodes 24-2 and the four nodes 34-2. The four nodes 24-2 perform calculations on the outputs from the four nodes 24-1 and the four nodes 34-1 by applying predetermined weightings thereto, and output results of these calculations to the four nodes 24-3.

In the present example, the four nodes 34-1 perform predetermined calculations on the six items of training input data 12 respectively indicated by X1 through X6 by applying predetermined weightings thereto, and output results of these calculations to the four nodes 34-2 and the four nodes 24-2. The four nodes 34-2 perform calculations on the outputs from the four nodes 34-1 and the four nodes 24-1 by applying predetermined weightings thereto, and output results of these calculations to the four nodes 34-3.

In the example of FIG. 7, the learning device 100 may also perform the first machine learning 60 and the second machine learning 70 by following the flowchart illustrated in FIG. 3. In the present example, the determination learning unit 20 (refer to FIG. 1) repeats the first machine learning 60 with respect to the nodes 24 and the nodes 34, and the ground learning unit 30 (refer to FIG. 1) repeats the second machine learning 70 with respect to the nodes 34 and the nodes 24. Accordingly, with respect to input data, the determination inference model 22 can output a highly accurate determination result that takes into account a learning result from the ground inference model 32. In addition, with respect to input data, the ground inference model 32 can output a highly accurate ground for a determination result that takes into account a learning result from the determination inference model 22.

The determination inference model 22 may include a node 34 on the input side, from the plurality of nodes 34 in the ground inference model 32. The ground inference model 32 may include a node 24 on the input side, from the plurality of nodes 24 in the determination inference model 22. In the example of FIG. 7, the determination inference model 22 includes the nodes 34-1 to which input data is inputted, and the ground inference model 32 includes the nodes 24-1 to which input data is inputted. By the determination inference model 22 including the nodes 34 on the input side and the ground inference model 32 including the nodes 24 on the input side, common calculation results are inputted to the nodes 24 and the nodes 34 on the output side. Accordingly, the learning device 100 can make the relatedness between the inferred determination data 26 and the inferred ground data 36 be strong.

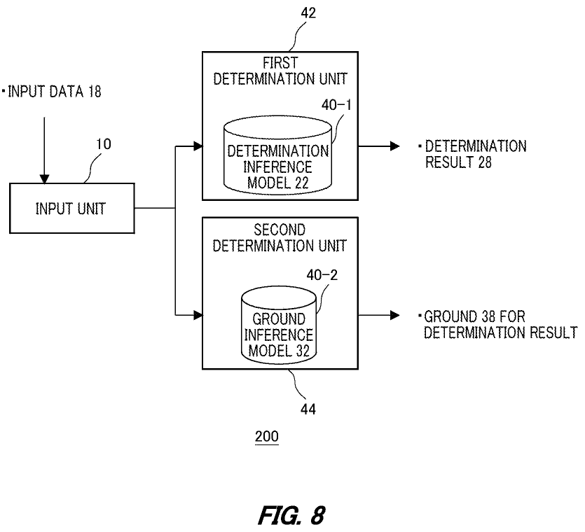

FIG. 8 illustrates an example of a determination device 200 according to one embodiment of the present invention. The determination device 200 is provided with the input unit 10, a first inference unit 42, and a second inference unit 44. Input data 18 is inputted to the input unit 10. The input unit 10 inputs the input data 18 to the first inference unit 42 and the second inference unit 44.

The first inference unit 42 outputs, based on the determination inference model 22, a determination result 28 with respect to the input data 18. The second inference unit 44 outputs, based on the ground inference model 32, a ground 38 for the determination result with respect to the input data 18. The determination inference model 22 may be a model that is generated by the determination learning unit 20 (refer to FIG. 1) for which the first machine learning 60 is complete. The ground inference model 32 may be a model that is generated by the ground learning unit 30 (refer to FIG. 1) for which the second machine learning 70 is complete. In other words, the determination inference model 22 and the ground inference model 32 may be models for which Yes is respectively determined in step S108 of the flowchart in FIG. 3. The determination inference model 22 may be saved in the storage unit 40-1. The ground inference model 32 may be saved in the storage unit 40-2.

The determination device 200 of the present example outputs the determination result 28 with respect to the input data 18 based on the determination inference model 22 generated by performing machine learning on the relationship between the training input data 12 and the training determination data 14. In addition, the determination device 200 of the present example outputs the ground 38 for the determination result with respect to the input data 18 based on the ground inference model 32 generated by performing machine learning on the relationship between the training input data 12 and the training ground data 16. Accordingly, the ground inference model 32 can output the ground 38 for the determination result that is easy for a user to interpret, with respect to the determination result 28.

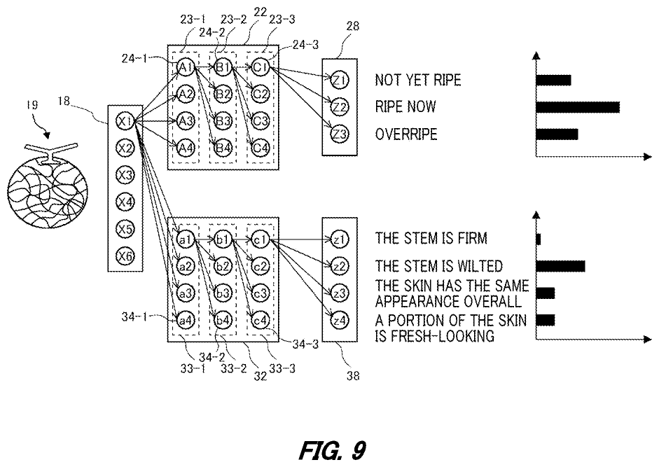

FIG. 9 illustrates an example of outputs for the determination result 28 and the ground 38 for the determination result, in accordance with the determination device 200. In the present example, the image data of a melon 18 is the determination target 19. The determination inference model 22 is generated by performing machine learning (the first machine learning 60) on determination results in which a human determiner or another type of determiner determines the quality of the determination target 19. The ground inference model 32 is generated by performing machine learning (the second machine learning 70) on grounds for determination results in which a human determiner or another type of determiner determines the quality of the determination target 19. The determination results include a plurality of results of a human determiner or another type of determiner determines the quality of the determination target 19. When the determiner is a human, the determination results include results of determining the quality of the determination target 19 as result of the human viewing the determination target 19 or from a sense resulting from touching the surface of the determination target 19. In the present example, the plurality of results includes three options: “not yet ripe”, “ripe now”, and “overripe”. In addition, the ground for the determination result includes a plurality of grounds for the determination by the human determiner or another type of determiner on the quality of the determination target 19. In the present example, the plurality of grounds includes four options: “the stem is firm”, “the stem is wilted”, “the skin has the same appearance overall”, and “a portion of the skin is fresh-looking”.

The determination result 28 may indicate respective probability values for the quality of the determination target 19 being any of “not yet ripe”, “ripe now”, and “overripe”. In FIG. 9, the probability values of the determination result 28 are illustrated in a histogram. The ground 38 for the determination result may indicate, as a ground for the determination result 28 with respect to the determination target 19, a corresponding probability value for any of “the stem is firm”, “the stem is wilted”, “the skin has the same appearance overall”, and “a portion of the skin is fresh-looking”. In FIG. 9, the probability values of the ground 38 for the determination result are illustrated in a histogram.

The determination device 200 of the present example can output both of the determination result 28 and the ground 38 for the determination result with respect to the input data 18 (the determination target 19). Accordingly, it is easier for a user to verify the appropriateness of the determination result 28 based on the ground 38 for the determination result. In addition, because the determination device 200 of the present example can also present the ground 38 for the determination result to a user who is presented with the determination result 28, it is easier for the user to interpret the determination result 28. In other words, the determination device 200 can output an answer that is equivalent to an answer when asking a human determiner or another type of determiner for a result of a determination on quality pertaining to a determination target, and a ground for the determination result. In addition, a human determiner or another type of determiner can learn a determination made with respect to the input data 18 (the determination target 19) by respectively comparing a determination result made by the determiner with respect to the input data 18 (the determination target 19) and a ground for the determination result with the determination result 28 based on the determination inference model 22 and the ground 38 for the determination result based on the ground inference model 32.

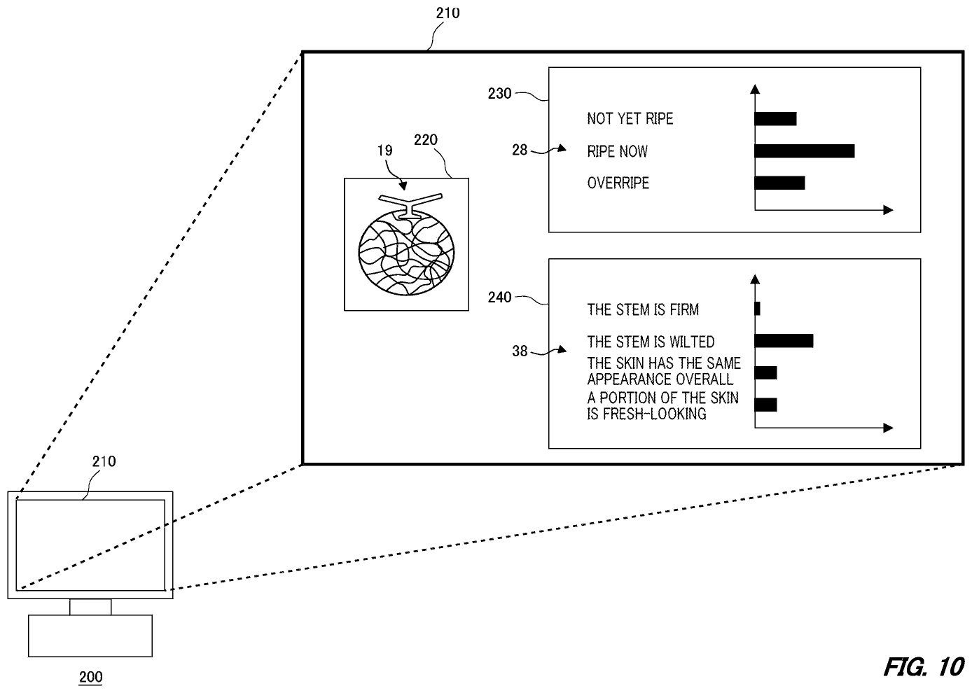

FIG. 10 illustrates an example of the determination device 200. As an example, the determination device 200 is a computer that is provided with a CPU, a memory, an interface, and the like.

The determination device 200 may be provided with a display unit 210. FIG. 10 also illustrates an enlarged view of the display unit 210 in a thick-line rectangular region. The display unit 210 may have a input data display region 220, a determination result display region 230, and a determination ground display region 240.

The input data display region 220 displays the input data 18. In the present example, the input data display region 220 displays an image of the determination target 19 as the input data 18. The determination result display region 230 displays the determination result 28. In the present example, the determination result display region 230 displays the probability value of each of three options as the determination result 28 on the quality of the determination target 19 that is outputted by the determination inference model 22. The three options include “not yet ripe”, “ripe now”, and “overripe”. The determination ground display region 240 displays the ground 38 for the determination result. In the present example, the determination ground display region 240 displays the probability value of each of four options as the ground 38 for the determination result for the quality of the determination target 19 that is outputted by the ground inference model 32. The four options include “the stem is firm”, “the stem is wilted”, “the skin has the same appearance overall”, and “a portion of the skin is fresh-looking”.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A learning device, comprising:
an input unit configured to input training input data, training determination data for indicating a determination result with respect to the training input data, and training ground data for indicating a ground for a determination result with respect to the training input data;
a determination learning unit configured to, by performing first machine learning that learns a relationship between the training input data and the training determination data, generate a determination inference model that, upon being inputted with input data, outputs inferred determination data for indicating a determination result with respect to the input data; and
a ground learning unit configured to, by performing second machine learning that learns a relationship between the training input data and the training ground data, generate a ground inference model that, upon being inputted with the input data, outputs inferred ground data for indicating a ground for the determination result with respect to the input data.

2. The learning device according to claim 1, wherein at least some nodes of the determination inference model differ from at least some nodes of the ground inference model.

3. The learning device according to claim 1, wherein at least one of the first machine learning and the second machine learning is performed based on a first error between the training determination data and the inferred determination data and a second error between the training ground data and the inferred ground data.

4. The learning device according to claim 2, wherein at least one of the first machine learning and the second machine learning is performed based on a first error between the training determination data and the inferred determination data and a second error between the training ground data and the inferred ground data.

5. The learning device according to claim 3, wherein both of the first machine learning and the second machine learning are performed based on the first error and the second error.

6. The learning device according to claim 4, wherein both of the first machine learning and the second machine learning are performed based on the first error and the second error.

7. The learning device according to claim 3, wherein at least one of the first machine learning and the second machine learning is performed so that a sum of the first error and the second error becomes a minimum.

8. The learning device according to claim 4, wherein at least one of the first machine learning and the second machine learning is performed so that a sum of the first error and the second error becomes a minimum.

9. The learning device according to claim 5, wherein at least one of the first machine learning and the second machine learning is performed so that a sum of the first error and the second error becomes a minimum.

10. The learning device according to claim 6, wherein at least one of the first machine learning and the second machine learning is performed so that a sum of the first error and the second error becomes a minimum.

11. The learning device according to claim 3, wherein at least one of the first machine learning and the second machine learning is performed by differently weighting the first error and the second error to differ.

12. The learning device according to claim 4, wherein at least one of the first machine learning and the second machine learning is performed by differently weighting the first error and the second error to differ.

13. The learning device according to claim 5, wherein at least one of the first machine learning and the second machine learning is performed by differently weighting the first error and the second error to differ.

14. The learning device according to claim 6, wherein at least one of the first machine learning and the second machine learning is performed by differently weighting the first error and the second error to differ.

15. The learning device according to claim 7, wherein at least one of the first machine learning and the second machine learning is performed by differently weighting the first error and the second error to differ.

16. The learning device according to claim 3, wherein
the determination learning unit is configured to perform the first machine learning, in which the first error is reduced, independently of the second machine learning;
the ground learning unit is configured to perform the second machine learning, in which the second error is reduced, independently of the first machine learning; and
the determination learning unit and the ground learning unit are respectively configured to perform the first machine learning and the second machine learning so that a sum of the first error and the second error becomes a minimum.

17. The learning device according to claim 1, wherein the determination inference model includes at least one node of the ground inference model.

18. The learning device according to claim 17, wherein the at least one node includes a node to which the input data is inputted.

19. A determination device, comprising:
a first inference unit configured to output a determination result with respect to input data, based on a determination inference model generated by performing machine learning on a relationship between training input data and training determination data; and
a second inference unit configured to output a ground for the determination result with respect to the input data, based on a ground inference model generated by performing machine learning on a relationship between the training input data and training ground data.

20. The determination device according to claim 19, comprising a display unit having
an input data display region configured to display the input data;
a determination result display region configured to display the determination result; and
a determination ground display region configured to display a ground of the determination result.
